(19) United States
(12) Patent Application Publication
(10) Pub. No.: US 2025/0110776 A1
(43) Pub. Date: Apr. 3, 2025

(54) HARDWARE QUEUE PRIORITY MECHANISM

(71) Applicant: ADVANCED MICRO DEVICES, INC., Santa Clara, CA (US)

(72) Inventors: Fabian Robert Sebastian Wildgrube, Mönkeberg (DE); Matthaeus G. Chajdas, Munich (DE)

(21) Appl. No.: 18/374,745

(22) Filed: Sep. 29, 2023

(51) Int. Cl. G06F 9/48; G06F 9/54

(52) U.S. Cl. CPC G06F 9/4881; G06F 9/54

(57) ABSTRACT

A processing system includes dispatch circuitry that sends elements to one or more processing circuits such as shader circuitry for execution. The dispatch circuitry includes a dispatch queue and an arbitration circuit. The dispatch queue stores the elements to be sent to the one or more processing circuits. The arbitration circuit schedules the elements of the dispatch queue for execution based on priority indicators corresponding to the elements. As a result, prioritization of the elements is implemented at the dispatch circuitry in hardware without changing a design of the dispatch queue to store the priority information.

### BACKGROUND

Parallel processors such as accelerator processors and graphics processing units (GPUs) implement graphics processing pipelines that concurrently process commands retrieved from a dispatch queue of a command buffer. In some cases, parallel processors include multiple processing elements (which are also referred to as processor cores, compute units, or workgroup processors) that execute different programs or concurrently execute multiple instances of a single program on multiple data sets as a single “wave,” (i.e., a group of threads running concurrently on a GPU). A graphics pipeline in a GPU includes one or more shader engines that execute using resources of the graphics pipeline such as compute units, memory, and caches. Shader engines are traditionally used for graphical lighting calculations. However, in modern computing, shader engines are often utilized as general-purpose processors that perform work separately from a graphics processing pipeline.

### BRIEF DESCRIPTION OF THE DRAWINGS

The present disclosure is better understood, and its numerous features and advantages made apparent to those skilled in the art, by referencing the accompanying drawings. The use of the same reference symbols in different drawings indicates similar or identical items.

FIG. 1 is a block diagram of a processing system that includes a hardware queue priority mechanism in accordance with some implementations.

FIG. 2 is a block diagram of example processing circuitry that implements a hardware queue priority mechanism in accordance with some implementations.

FIG. 3 is a block diagram showing example dispatch circuitry of a hardware queue priority mechanism in accordance with some implementations.

FIG. 4 is a flow diagram of a method of prioritizing elements in a hardware queue in accordance with some implementations.

### DETAILED DESCRIPTION

In some implementations, a parallel processor such as an accelerated processing device or GPU includes shader circuitry such as one or more shader engines, where each shader engine includes a respective quantity of compute units. Based on one or more commands to be executed, a command processor generates a plurality of workgroups (collections of processing threads) for assignment to the shader circuitry for processing. Assigning the workgroups to the shader circuitry includes sending elements from the commands to dispatch circuitry. The dispatch circuitry schedules the elements for processing at the shader circuitry. In some processing systems, dispatch circuitry includes a dispatch queue that outputs received elements based on insertion order in a fixed manner. For example, in some cases, dispatch queues store elements in a first in first out (FIFO) or first in last out (stacked) manner. However, in some cases (e.g., Quality of Service or Work Graph processes), it is desirable to prioritize execution using certain elements over other elements. However, because the dispatch queue is implemented in a fixed manner, execution priority is difficult to implement.

In some processing systems that include a dispatch queue, priority is implemented by using multiple hardware queues where some hardware queues are prioritized to dispatch instructions over other hardware queues in a fixed manner. However, such systems inherently have a fixed number of priority levels corresponding to the number of hardware queues and inefficiently use power and area for queue entries that do not frequently store elements. In other processing systems that include a dispatch queue, software implemented with synchronization primitives (e.g., locks) is used to prioritize certain elements. However, in some cases, the software introduces an undesirable delay between when elements are received and when an element is identified to be dispatched.

Using the techniques disclosed herein, in some implementations, dispatch circuitry includes an arbitration circuit that stores priority indicators corresponding to respective elements of a dispatch queue. The arbitration circuit schedules the elements of the dispatch queue for execution at shader circuitry based on the priority indicators. As a result, prioritization is implemented at the dispatch circuitry in hardware without changing a design of the dispatch queue to store priority information. Further, in some implementations, the arbitration circuit enables the dispatch circuitry to use more priority levels and with less wasted power and area, as compared to dispatch circuitry where each priority level corresponds to a different dispatch queue.

The techniques described herein are, in different implementations, employed using any of a variety of parallel processors (e.g., vector processors, graphics processing units (GPUs), general-purpose GPUs (GPGPUs), non-scalar processors, highly-parallel processors, artificial intelligence (AI) processors, inference engines, machine learning processors, other multithreaded processing units, and the like). For ease of illustration, reference is made herein to example systems and methods in which processing circuits are employed. However, it will be understood that the systems and techniques described herein apply equally to the use of other types of parallel processors unless otherwise noted.

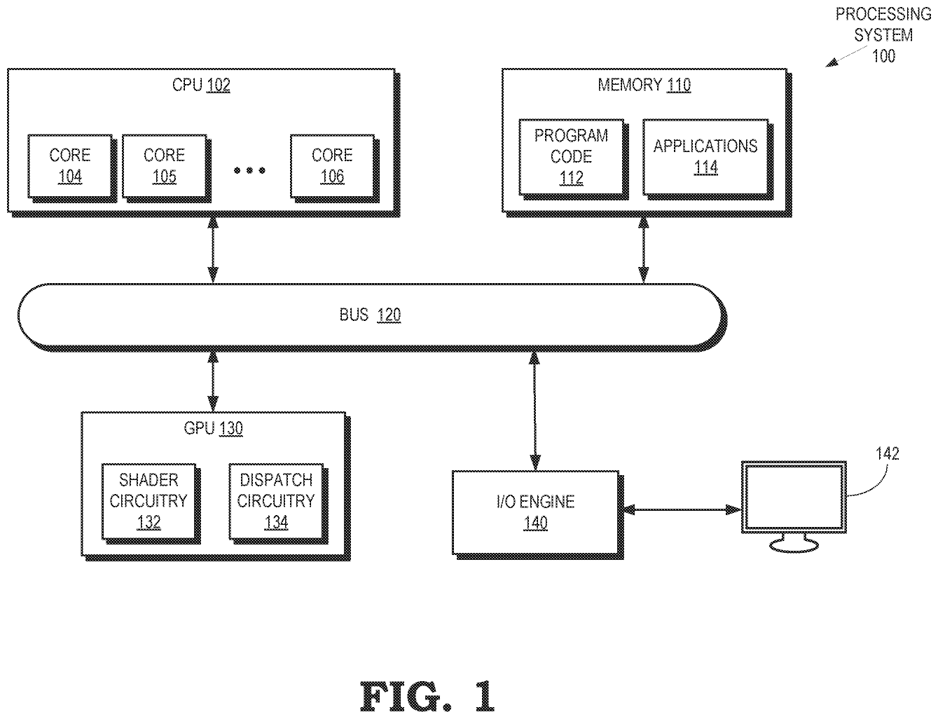

Referring now to FIG. 1, a processing system 100 that includes a hardware queue priority mechanism is presented, in accordance with some embodiments. Processing system 100 includes or has access to memory 110 or other storage component implemented using a non-transitory computer-readable medium such as a dynamic random-access memory (DRAM). However, in some implementations, memory 110 is implemented using other types of memory including, for example, static random-access memory (SRAM), nonvolatile RAM, and the like. According to some implementations, memory 110 includes an external memory implemented external to the processing units implemented in the processing system 100. Processing system 100 also includes bus 120 to support communication between entities implemented in processing system 100, such as memory 110. Some implementations of processing system 100 include other buses, bridges, switches, routers, and the like, which are not shown in FIG. 1 in the interest of clarity.

The techniques described herein are, in different implementations, employed at graphics processing unit (GPU) 130. GPU 130 includes, for example, vector processors, coprocessors, graphics processing units (GPUs), general-purpose GPUs (GPGPUs), non-scalar processors, highly parallel processors, artificial intelligence (AI) processors, inference engines, machine-learning processors, other multithreaded processing units, scalar processors, serial processors, programmable logic devices (simple programmable logic devices, complex programmable logic devices, field programmable gate arrays (FPGAs), or any combination thereof. FIG. 1 illustrates an example of a parallel processor, and in particular GPU 130, in accordance with some implementations. In some implementations, GPU 130 renders images for presentation on display 142. For example, GPU 130 renders objects to produce values of pixels that are provided to display 142, which uses the pixel values to display an image that represents the rendered objects. In some implementations, rather than sending values to display 142 via input/output (I/O) engine 140 as illustrated in FIG. 1, GPU 130 sends values to display 142 directly.

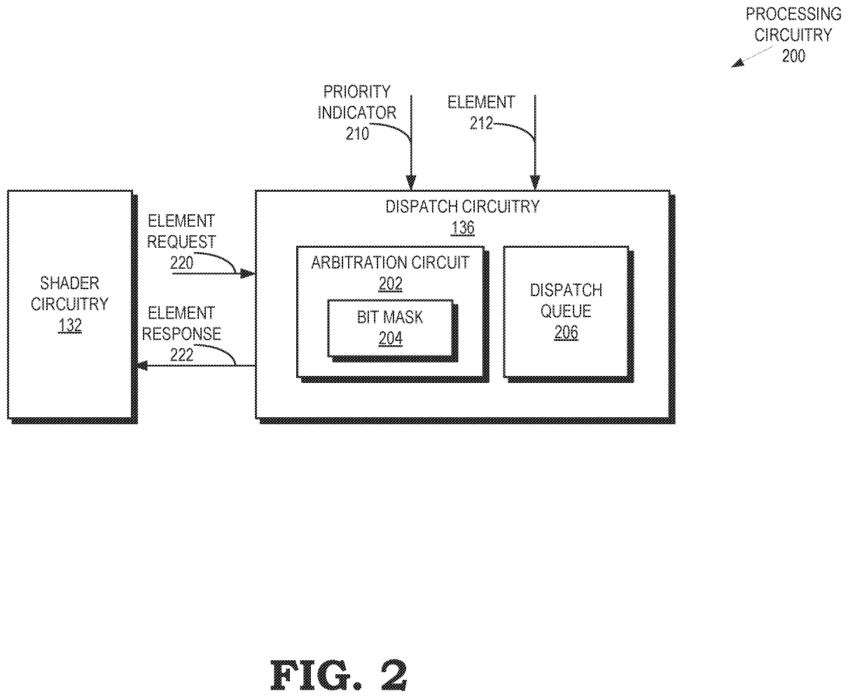

GPU 130 includes shader circuitry 132 that implements a plurality of execution units (e.g., shader engines) that are each able to execute one or more instructions separately or in parallel. In some implementations, shader circuitry 132 includes execution units implemented as one or more single-instruction-multiple-data (SIMD) units, compute units, processor cores, and the like. For example, in some implementations shader circuitry 132 includes one or more execution units to perform operations for one or more instructions in parallel received from a graphics pipeline. To facilitate the performance of operations by the compute units, GPU 130 includes one or more command processors (not shown for clarity). Such command processors, for example, include circuitry configured to execute one or more instructions from a graphics pipeline by providing data indicating one or more operations, operands, instructions, variables, register files, or any combination thereof to one or more compute units necessary for, helpful for, or aiding in the performance of one or more operations for the instructions. In the illustrated implementation, the command processors include dispatch circuitry 134, which is used to provide data values used for execution, referred to herein as “elements,” to execution units of shader circuitry 132. As further discussed below with reference to FIGS. 2-4, in various implementations, dispatch circuitry 134 manages priorities associated with elements, causing some elements to be processed more quickly, as compared to other elements. Some implementations of GPU 130 are used for general-purpose computing. For example, in embodiments, GPU 130 receives one or more instructions, such as program code 112, from one or more applications 114 that indicate operations associated with, for example, one or more video tasks, physical simulation tasks, computational tasks, fluid dynamics tasks, or any combination thereof. In response to receiving program code 112, GPU 130 executes the instructions for the video tasks, physical simulation tasks, computational tasks, and fluid dynamics tasks. GPU 130 then stores information in memory 110 such as the results of the executed instructions.

In some implementations, processing system 100 includes input/output (I/O) engine 140 that includes circuitry to handle input or output operations associated with display 142, as well as other elements of the processing system 100 such as keyboards, mice, printers, external disks, and the like. I/O engine 140 is coupled to bus 120 so that I/O engine 140 communicates with memory 110, GPU 130, central processing unit (CPU) 102, or any combination thereof.

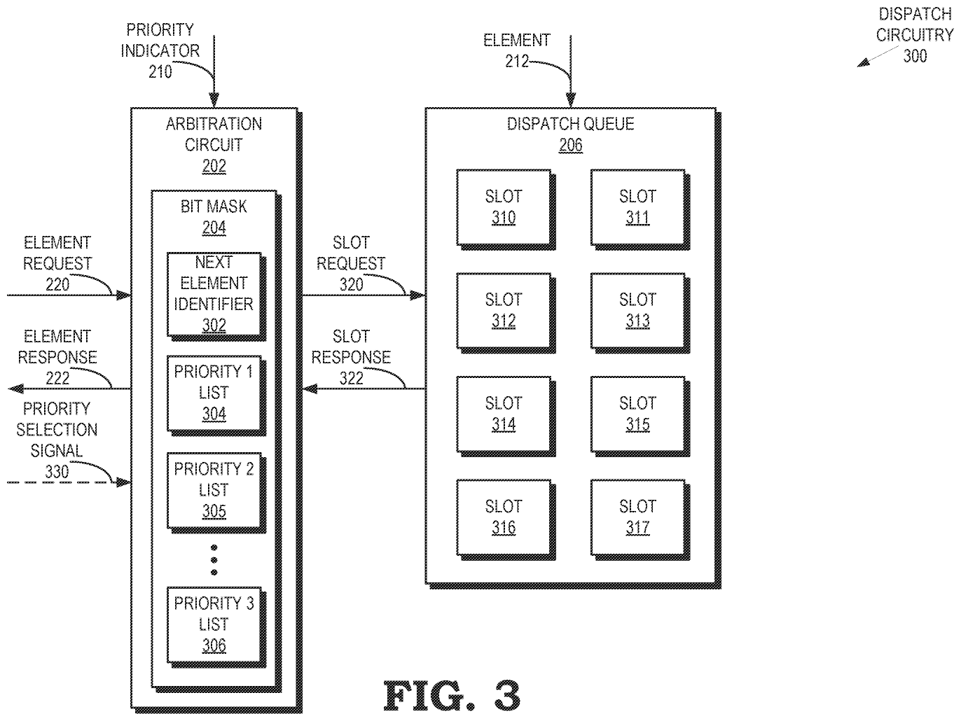

In some implementations, processing system 100 also includes CPU 102 that communicates with GPU 130 and memory 110 via bus 120. CPU 102 implements a plurality of processor cores 104, 105, and 106 that execute instructions concurrently or in parallel. In various implementations, one or more of the processor cores 104 operate as SIMD units that perform the same operation on different data sets. Though in the example implementation illustrated in FIG. 1, three processor are presented, the number of processor cores implemented in CPU 102 is a matter of design choice. As such, in other implementations, CPU 102 can include any number of processor cores. In some implementations, CPU 102 has an equal number of processor cores as GPU 130 has execution units in shader circuitry 132. In other implementations, the number of processor cores of CPU 102 differs from the number of execution units in shader circuitry 132 of GPU 130. Processor cores 104-106 of CPU 102 execute instructions such as program code 112 for one or more applications 114 (e.g., graphics applications, compute applications, machine-learning applications) stored in memory 110, and CPU 102 stores information in memory 110 such as the results of the executed instructions. In some implementations, CPU 102 initiates processing at GPU 130 such as by issuing draw calls to GPU 130. As further discussed below with reference to FIGS. 2 and 3, in some cases, instructions sent from CPU 102 to GPU 130 include elements and priority indicators, which are used to prioritize processing using the elements. In some implementations, CPU 102 runs user software or includes an application programmer interface (API) that enables users to specify priorities of elements. In some implementations, CPU 102 runs a driver that specifies priorities of elements based on a status of a user-visible process that is to use data generated using the element.

FIG. 2 is a block diagram illustrating processing circuitry 200 that includes an example hardware queue priority mechanism. In some implementations, processing circuitry 200 depicts a subset of processing system 100 of FIG. 1. For example, in the illustrated implementation, processing circuitry 200 includes shader circuitry 132 and dispatch circuitry 136 of FIG. 1. However, in other implementations, processing circuitry 200 corresponds to a different system that includes additional or fewer components than processing system 100. In the illustrated implementation, dispatch circuitry 136 includes arbitration circuit 202 and dispatch queue 206. Arbitration circuit 202 includes bit mask 204. Although the illustrated implementation shows a specific configuration of components, in various implementations, other combinations or arrangements of components are contemplated. For example, in some implementations, processing circuitry 200 includes memory circuitry from which elements stored at dispatch queue 206 are retrieved. As another example, in some implementations, shader circuitry 132 is separate from processing circuitry 200.

As discussed above with reference to FIG. 1, shader circuitry 132 includes one or more execution units that are each able to execute one or more instructions separately or in parallel. The execution of instructions is performed using elements, which are received at shader circuitry 132 via element response 222. Accordingly, shader circuitry 132 executes instructions using elements received from dispatch circuitry 136.

Dispatch circuitry 136 organizes and schedules elements for execution by shader circuitry 132. Elements, such as element 212, are received at dispatch circuitry (e.g., from memory circuitry of GPU 130 or from an instruction received from another circuit such as one of cores 104-106). The elements are stored at dispatch queue 206, which includes a plurality of slots configured to store the elements. In response to element request 220, dispatch circuitry 136 retrieves an element from dispatch queue 206 and sends element response 222 to shader circuitry 132, indicating the retrieved element as a next element to be processed. In some implementations, element request 220 is received from shader circuitry 132 directly. In other implementations, element request 220 is received from another circuit, such as a portion of a command processor of GPU 130. In other implementations, element request 220 is not received at all and instead dispatch circuitry 136 is to periodically send an element to shader circuitry 132 (e.g., every clock cycle).

As discussed above, in some cases it is desirable to prioritize certain elements over other elements. However, dispatch queue 206 is not natively configured to dequeue high priority elements first. Arbitration circuit 202 is used to implement priority at dispatch queue 206. In particular, as further discussed below with reference to FIG. 3, arbitration circuit 202 stores, at bit mask 204, a plurality of priority indicators corresponding to respective elements of dispatch queue 206. Arbitration circuit 202 schedules the elements for execution at shader circuitry 132 based on the stored priority indicators. The priority indicators, such as priority indicator 210, are received at dispatch circuitry (e.g., from memory circuitry of GPU 130 or from an instruction received from another circuit such as one of cores 104-106). In some implementations, priority indicators are received together with corresponding elements. In other implementations, priority indicators are received separately from the corresponding elements. In some implementations, priority indicators are extracted from a received opcode corresponding to the element. In some implementations, priority indicators are related to the processes that generate the elements. For example, in some cases, priority indicators are identifiers of respective processes that correspond to the elements. As another example, in some cases, priority indicators are identifiers of respective virtual machines that correspond to the elements.

As a result, a priority mechanism is implemented for the elements stored at dispatch queue 206, allowing for more flexible dequeuing and supporting high priority elements.

FIG. 3 is a block diagram illustrating dispatch circuitry 300 that implements an example hardware queue priority mechanism. In some implementations, dispatch circuitry 300 corresponds to dispatch circuitry 136 of FIGS. 1 and 2. For example, in the illustrated implementation, dispatch circuitry 300 includes arbitration circuit 202, bit mask 204, and dispatch queue 206 of FIG. 2. However, in other implementations, dispatch circuitry 300 corresponds to a different system that includes additional or fewer components than dispatch circuitry 136. In the illustrated implementation, bit mask 204 includes next element identifier 302, priority 1 list 304, priority 2 list 305, and priority 3 list 306. Dispatch queue 206 includes slot 310, slot 311, slot 312, slot 313, slot 314, slot 315, slot 316, and slot 317. Although the illustrated implementation shows a specific configuration of components, in various implementations, other combinations or arrangements of components are contemplated. For example, in some implementations, dispatch queue 206 includes more than eight slots or fewer than eight slots. As another example, in some implementations, bit mask 204 only includes two priority lists or does not include next element identifier 302.

Elements and corresponding priority indicators are received at dispatch circuitry 300. For example, element 212 and priority indicator 210 are received together as part of an opcode and corresponding operand. Dispatch queue 206 stores element 212 in one of slots 310-317 according to a configuration of dispatch queue 206 (e.g., a stack configuration or a FIFO configuration). In response to receiving a slot request (e.g., slot request 320) from arbitration circuit 202, dispatch queue 206 provides the element stored at a slot identified by the request in a slot response (e.g., slot response 322).

Arbitration circuit 202 identifies a priority of element 212 identified by priority indicator 210 and sorts one or more priorities at arbitration circuit 202 based on the received priority. For example, in response to priority indicator 210 indicating that element 212 has a first priority level, arbitration circuit 202 identifies element 212 in priority 1 list 304. In some cases, identifying element 212 in priority 1 list 304 causes arbitration circuit 202 to prioritize element 212 over other elements received at dispatch queue 206 prior to element 212 (e.g., elements identified by priority 2 list 305). As a result, in some cases, in response to element request 220, arbitration circuit 202 identifies element 212 rather than a previously stored element, even if dispatch queue 206 is configured as a FIFO queue. In response to identifying an element, arbitration circuit 202 requests the identified element from dispatch queue 206 via slot request 320 and sends a received element from slot response 322 as part of element response 222. In some implementations, the priorities of arbitration circuit 202 correspond to respective slots of dispatch queue 206. In some implementations, different priority lists correspond to different priority levels. For example, elements identified by priority 2 list 305 have a lower priority level than elements identified by priority 1 list 304. In other implementations, as further discussed below, different priority lists correspond to other factors such as the presence of priority selection signal 330.

In some implementations, arbitration circuit 202 includes additional prioritization features. For example, in the illustrated implementation, arbitration circuit 202 includes next element identifier 302, which indicates a next element to be scheduled. The element identified by next element identifier 302 is identified in response to receiving a priority indicator (e.g., priority indicator 210). As a result, rather than arbitration circuit 202 searching one or more priority lists in response to element request 220, arbitration circuit 202 refers to next element identifier 302 in element response 222, sending element response 222 more quickly as compared to an implementation where next element identifier 302 is not stored at bit mask 204. In some implementations, the element identified by next element identifier 302 is prefetched, further reducing response time to an element request. In other implementations, next element identifier 302 is not stored at bit mask 204, saving power and area as compared to a system that stores next element identifier.

As another example, in some implementations, arbitration circuit 202 includes priority inversion protection. More specifically, as a way of guaranteeing elements will eventually be dispatched, priority 2 list 305 has a threshold number of dispatches after which an element identified by priority 2 list 305 is scheduled. Similarly, priority 3 list 306 has a second threshold number of dispatches after which an element identified by priority 3 list 306 is scheduled.

As another example, in some implementations, some priority lists depend on additional signals, such as priority selection signal 330. To illustrate, in some implementations, processing elements is dependent upon the availability of multiple types of hardware circuits (e.g., processing resources), such as shader circuitry availability or memory circuit availability. Accordingly, in those implementations, in the absence of priority selection signal 330 indicating that memory is available, arbitration circuit 202 schedules elements using a first priority list (e.g., priority 1 list 304). However, in response to priority selection signal 330 indicating that memory is available, arbitration circuit 202 schedules elements using a different priority list (e.g., priority 2 list 305).

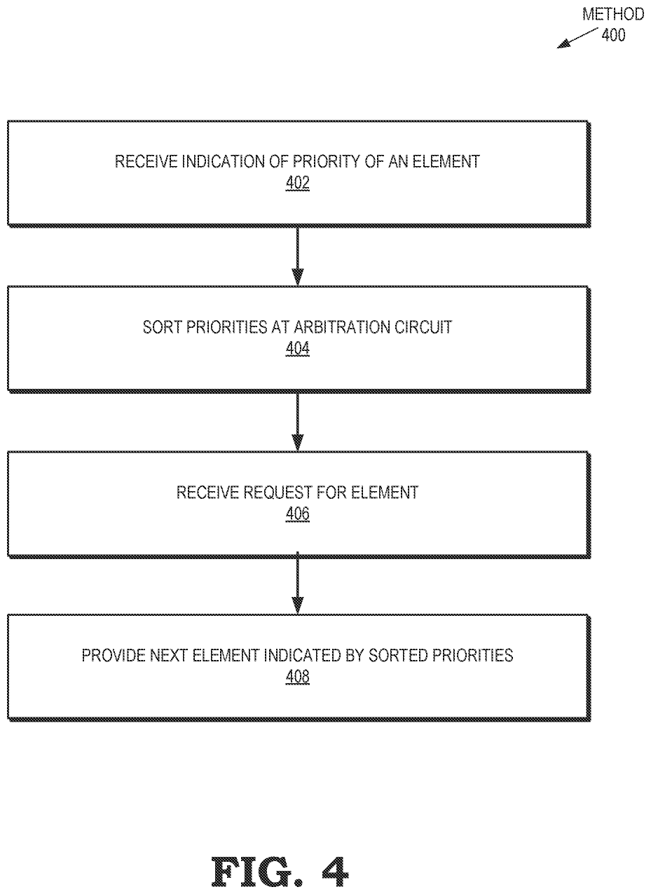

FIG. 4 is a flow diagram illustrating a method 400 of prioritizing elements in a hardware queue in accordance with some implementations. In some implementations, various portions are performed in another order. For example, in some implementations, a determination of whether a processing circuit is performing a critical or non-critical process is performed before a determination of whether a memory request addresses critical data. In some implementations, method 400 is initiated by one or more processors in response to one or more instructions stored by a computer readable storage medium.

At block 402, an indication of a priority of an element is received. For example, priority indicator 210 is received at arbitration circuit 202 of FIG. 3. At block 404, priorities at an arbitration circuit are sorted. For example, one or more of priority lists 304-306 are modified to include an indication corresponding to priority indicator 210.

At block 406, a request for an element is received. For example, arbitration circuit 202 receives element request 220. At block 408, a next element indicated by the sorted priorities is provided. For example, arbitration circuit 202 provides element response 222 indicating a next element to be scheduled based on one or more of priority lists 304-306. Accordingly, a method prioritizing elements in a hardware queue is depicted.

In some implementations, a computer readable storage medium includes any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), or Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. In some implementations, the computer readable storage medium is embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some implementations, certain aspects of the techniques described above are implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. In some implementations, the executable instructions stored on the non-transitory computer readable storage medium are in source code, assembly language code, object code, or other instruction format that is interpreted or otherwise executable by one or more processors.

Note that not all of the activities or elements described above in the general description are required, that a portion of a specific activity or device are not required, and that, in some cases, one or more further activities are performed, or elements included, in addition to those described. Still further, the order in which activities are listed are not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that cause any benefit, advantage, or solution to occur or become more pronounced are not to be construed as a critical, required, or essential feature of any or all the claims. Moreover, the particular implementations disclosed above are illustrative only, as the disclosed subject matter could be modified and practiced in different but equivalent manners apparent to those skilled in the art having the benefit of the teachings herein. No limitations are intended to the details of construction or design shown herein, other than as described in the claims below. It is therefore evident that the particular implementations disclosed above could be altered or modified and all such variations are considered within the scope of the disclosed subject matter. Accordingly, the protection sought herein is as set forth in the claims below.

One or more of the elements described above is circuitry designed and configured to perform the corresponding operations described above. Such circuitry, in at least some implementations, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations the sequence of operations for a particular element is defined in a specified computer language, such as a register transfer language, and a computer-implemented design tool selects, configures, and arranges the circuitry based on the defined sequence of operations. “Circuitry” and “circuit” are used herein interchangeably.

Within this disclosure, in some cases, different entities (which are variously referred to as “components,” “units,” “devices,” “circuitry,” etc.) are described or claimed as “configured” to perform one or more tasks or operations. This formulation-[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

What is claimed is:

1. A system comprising:
a dispatch queue configured to store elements to be executed by shader circuitry; and
an arbitration circuit configured to store a plurality of priority indicators corresponding to respective elements of the dispatch queue, wherein the arbitration circuit is configured to schedule the elements of the dispatch queue for execution at the shader circuitry based on the plurality of priority indicators.

2. The system of claim 1, wherein scheduling the elements of the dispatch queue for execution comprises, in response to receiving a particular priority corresponding to a particular element, identifying a next element to be sent to the shader circuitry.

3. The system of claim 2, wherein identifying the next element to be sent to the shader circuitry is performed prior to receiving a corresponding request for the next element to be sent to the shader circuitry.

4. The system of claim 1, wherein the dispatch queue comprises a plurality of slots configured to store respective elements, and wherein the plurality of priority indicators correspond to respective slots of the plurality of slots.

5. The system of claim 1, wherein scheduling the elements of the dispatch queue for execution comprises scheduling at least one element having a second priority in response to scheduling a threshold number of elements having a first priority, wherein the second priority is a lower priority than the first priority.

6. The system of claim 1, wherein the plurality of priority indicators are identifiers of respective processes that correspond to the elements.

7. The system of claim 1, wherein the plurality of priority indicators are identifiers of respective virtual machines that correspond to the elements.

8. The system of claim 1, wherein the arbitration circuit is further configured to store a second plurality of priority indicators, and wherein scheduling the elements of the dispatch queue for execution comprises selecting, based on a priority selection signal, between an element indicated by the plurality of priority indicators and an element indicated by the second plurality of priority indicators.

9. The system of claim 8, wherein the priority selection signal is indicative of availability of a hardware circuit.

10. The system of claim 9, wherein the hardware circuit is a memory circuit or the shader circuitry.

11. A method, comprising:
receiving, at an arbitration circuit, an indication of a priority of an element to be executed by shader circuitry, wherein the element is stored at a dispatch queue;
sorting priorities stored at the arbitration circuit based on the indication of the priority; and
in response to a request for an element, providing a next element indicated by the sorted priorities to the shader circuitry.

12. The method of claim 11, wherein the priority indicates that the element has a first priority and wherein a second element currently stored at the dispatch queue has a second priority.

13. The method of claim 11, wherein receiving the indication of the priority comprises extracting the priority from a received opcode corresponding to the element.

14. The method of claim 11, wherein the indication of the priority of the element is specified by a user.

15. The method of claim 11, wherein the indication of the priority of the element is specified by a driver based on a status of a user-visible process that is to use data generated using the element.

16. A processing system, comprising:
a bus;
a first processing circuit configured to issue a plurality of commands via the bus; and
a second processing circuit configured to receive the plurality of commands from the first processing circuit, and comprising:
a dispatch queue configured to store a plurality of elements from the plurality of commands;
shader circuitry configured to process the plurality of elements; and
an arbitration circuit configured to store a plurality of priority indicators corresponding to respective elements of the plurality of elements and to schedule the respective elements for processing by the shader circuitry based on the plurality of priority indicators.

17. The processing system of claim 16, wherein scheduling the elements of the dispatch queue for processing comprises, in response to receiving a request for an element, sending a previously identified element to the shader circuitry.

18. The processing system of claim 17, wherein the arbitration circuit is further configured to prefetch the previously identified element.

19. The processing system of claim 16, wherein scheduling the elements of the dispatch queue for processing comprises, in response to receiving a request for an element, identifying a next element to send to the shader circuitry.

20. The processing system of claim 16, wherein scheduling the elements of the dispatch queue for processing comprises schedule at least one element having a second priority in response to scheduling a threshold number of elements having a first priority, wherein the second priority is a lower priority than the first priority.
